(19) United States
(12) Patent Application Publication
(10) Pub. No.: US 2026/0025188 A1
(43) Pub. Date: Jan. 22, 2026

(54) METHOD AND APPARATUS FOR BEAM INFORMATION

(71) Applicant: SAMSUNG ELECTRONICS CO., LTD., Suwon-si, Gyeonggi-do (KR)

(72) Inventors: Qi XIONG, Beijing (CN); Zhe CHEN, Beijing (CN); Sa ZHANG, Beijing (CN)

(21) Appl. No.: 18/995,051

(22) PCT Filed: May 22, 2023
(86) PCT No.: PCT/KR2023/006884

§ 371 Date: Jan. 15, 2025

(30) Foreign Application Priority Data
Jul. 25, 2022 (CN) 202210880655.7
Sep. 29, 2022 (CN) 202211204542.1

(51) Int. Cl. H04B 7/06; H04B 7/0456; H04W 72/23

(52) U.S. Cl. CPC H04B 7/06952; H04B 7/0456; H04W 72/23

(57) ABSTRACT

The disclosure relates to a 5G or 6G communication system for supporting a higher data transmission rate. The disclosure provides a transmitting method, receiving method and a corresponding device for beam information. The method comprises receiving, from a base station, information related to signal beams related to a first mode of the base station; and performing an operation related to communication based on the information related to the signal beams related to the first mode of the base station.

### TECHNICAL FIELD

The present disclosure relates to wireless communication system. More specifically, the present invention relates to a method and apparatus for beam information in wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Currently, there are needs to enhance transmitting and receiving beam information in a wireless communication system.

### Solution to Problem

According to an embodiment of the disclosure, a method performed by a user equipment UE is provided, which comprises receiving, from a base station, information related to signal beams related to a first mode of the base station; and performing an operation related to communication based on the information related to the signal beams related to the first mode of the base station.

In an implementation, wherein the information related to the signal beams related to the first mode of the base station comprises at least one of: a pattern of beams related to the first mode of the base station for indicating transmit beam index information related to the first mode of the base station; information of the signal beams for indicating the beams related to the first mode of the base station; a pattern of an antenna array for indicating antennas related to the first mode of the base station; codebook information for multiple-input multiple output MIMO transmission; boresight direction information of the beam; beam width information; a beam change flag for indicating whether a beam configuration is adjusted to be related to the first mode of the base station; and information for indicating whether to initiate the first mode.

In an implementation, wherein the pattern of the beams related to the first mode of the base station further comprises at least one of: information on the number of time units corresponding to the period of the beams related to the first mode of the base station, information on the number of time units occupied by the beams related to the first mode of the base station in a period, information on the number and/or location index of the beams related to the first mode of the base station in a period.

In an implementation, wherein the operation related to communication comprises at least one of: measuring the signal beams related to the first mode of the base station, and reporting a measurement result and/or a preferred beam index; determining whether the resources corresponding to the indexes of the signal beams are valid or available based on whether the signal beams related to the first mode of the base station are turned off; receiving, from the base station, first delay configuration information related to the first mode for scheduled uplink signal transmission; obtaining, through the PDCCH and/or PDSCH in the obtained message 4, a transmit beam index indication of the PUCCH indicated by the base station, wherein the transmit beam index indication comprises a transmit beam index corresponding to the corresponding downlink beam index; performing at least one of the following operations on a contention resolution timer in random access procedure: extend, stop, reset, pause and restart.

In an implementation, wherein the measurement result and/or the preferred beam index are reported through a PRACH, a msg3 PUSCH or a msgA PUSCH, wherein, determining whether the resources corresponding to the indexes of the signal beams are valid or available based on whether the signal beams related to the first mode of the base station are turned off comprises: if the beams related to the first mode of the base station are turned off, determining that the random access channel RACH resources corresponding to the beam indexes are unavailable or invalid; if the beams related to the first mode of the base station are not turned off, determining that the RACH resources corresponding to the beam indexes are available or valid, wherein the first delay configuration information comprises a first number of time units, and receiving, from the base station, first delay configuration information related to the first mode for scheduled uplink signal transmission comprises at least one of: receiving, through a random access response RAR or a RAR uplink UL grant of a message msg2, the first delay configuration information for uplink transmission scheduled by the RAR UL grant; receiving, through a physical downlink control channel PDCCH corresponding to a msg3, the first delay configuration information for uplink transmission of msg3 retransmission scheduled by a downlink control information DCI UL grant in the PDCCH; receiving, through a msg4 PDCCH and/or a physical downlink shared channel PDSCH, the first delay configuration information for transmission of the PUCCH corresponding to the PDCCH and/or PDSCH.

In an implementation, wherein the operation related to communication is performed after a second number of time units after receiving the information related to signal beam adjustment.

In an implementation, wherein the second number is pre-configured and/or configured fixedly and/or configured dynamically.

In an implementation, wherein the information related to the signal beams related to the first mode of the base station is received by at least one of: implicit indication of the information related to the signal beams related to the first mode of the base station; a specific common search space CSS and/or a specific control resource set CORESET; the PDCCH and/or PDSCH corresponding to at least one of a msg2, a msgB and a msg4 in random access procedure, and/or the PDCCH scheduling the msg3 retransmission.

In an implementation, wherein: the signal is a synchronization signal block SSB, and the implicit indication relates to at least one of: using a sequence specific to the first mode; using a demodulation reference signal DMRS sequence in a main information block MIB specific to the first mode; carrying the information related to the signal beam related to the first mode of the base station in the content of a MIB; using SSB time domain and/or frequency domain resource locations specific to the first mode.

In an implementation, wherein the specific common search space CSS and/or the specific control resource set CORESET comprise at least one of: a CSS/CORESET specific to the first mode; a DCI format specific to the first mode, wherein the DCI carries the information related to the signal beams related to the first mode of the base station; an existing DCI format carrying the information related to the signal beams related to the first mode of the base station in the reserved bit field, a DCI format carrying a DL grant, wherein the PDSCH corresponding to the DL grant comprises the information related to the signal beams related to the first mode of the base station, the PDCCH and/or PDSCH corresponding to at least one of a msg2, a msgB and a msg4 in random access procedure, and/or the PDCCH scheduling the msg3 retransmission relates to at least one of: the reserved bit field in the DCI format of the PDCCH corresponding to at least one of the msg2, the msgB and the msg4 and/or the PDCCH scheduling the msg3 retransmission carries the information related to the signal beams related to the first mode of the base station; the MAC subheader in the PDSCH of the msg2 or msgB carries the information related to the signal beams related to the first mode of the base station; the RAR in the PDSCH of the msg2 or msgB carries the information related to the signal beams related to the first mode of the base station.

In an implementation, wherein the PDSCH corresponding to the DL grant comprises a PDSCH specific to the first mode or a system information block SIB specific to the first mode.

In an implementation, wherein the information related to the signal beams related to the first mode of the base station is received from the base station under a first condition, the first condition comprises at least one of: an aggregation level of a search space of the UE satisfying a first threshold; a serving base station of the UE entering the first mode; the UE receiving an indication that the base station initiates the first mode; the beam selected by the UE being adjusted or changed, wherein the selected beam comprises a preferred beam that the UE has reported to the base station.

In an implementation, the signal beam comprises a beam of at least one of a SSB, a CSI-RS and a PRS signal.

According to an embodiment of the disclosure, a method performed by a base station in a communication system is provided, which comprises transmitting, to a user equipment UE, information related to signal beams related to a first mode.

In an implementation, wherein the information related to the signal beams related to the first mode of the base station comprises at least one of: a pattern of beams related to the first mode of the base station for indicating transmit beam index information related to the first mode of the base station; information of the signal beam for indicating the beam related to the first mode of the base station; a pattern of an antenna array for indicating antennas related to the first mode of the base station; codebook information for multiple-input multiple output MIMO transmission; boresight direction information of the beams; beam width information; a beam change flag for indicating whether a beam configuration is adjusted to be related to the first mode of the base station; information for indicating whether to initiate the first mode.

In an implementation, wherein the pattern of the beams related to the first mode further comprises at least one of: information on the number of time units corresponding to the period of the beams related to the first mode of the base station, information on the number of time units occupied by the beams related to the first mode of the base station in a period, information on the number of beams and/or location index information of the beam related to the first mode of the base station in a period.

In an implementation, the method further comprises at least one of: receiving, from the UE, a measurement result and/or a preferred beam index reported after measuring the signal beams related to the first mode; transmitting, to the UE, first delay configuration information related to the first mode for scheduled uplink signal transmission, indicating, to the UE through the PDCCH and/or PDSCH in a message msg4, a transmit beam index of the PUCCH, wherein the transmit beam index comprises a transmit beam index corresponding to the corresponding downlink beam index.

In an implementation, wherein the measurement result and/or the preferred beam index are received through a PRACH, a msg3 PUSCH, or a msgA PUSCH, wherein the first delay configuration information comprises a first number of time units, and transmitting, to the UE, first delay configuration information related to the first mode for scheduled uplink signal transmission comprises at least one of: transmitting, through a RAR or a RAR UL grant of a msg2, the first delay configuration information for uplink transmission scheduled by the RAR UL grant; transmitting, through a PDCCH corresponding to a msg3, the first delay configuration information for uplink transmission of msg3 retransmission scheduled by a DCI UL grant in the PDCCH; transmitting, through a msg4 PDCCH and/or PDSCH, the first delay configuration information for transmission of the PUCCH corresponding to the PDCCH and/or PDSCH.

In an implementation, wherein the information related to the signal beams related to the first mode of the base station is indicated by at least one of: implicit indication of the information related to the signal beam related to the first mode of the base station; a specific common search space CSS and/or a specific control resource set CORESET; the PDCCH and/or PDSCH corresponding to at least one of a msg2, a msgB and a msg4 in random access procedure, and/or the PDCCH scheduling the msg3 retransmission.

In an implementation, wherein: the signal is an SSB, and the implicit indication relates to at least one of: using a sequence specific to the first mode; using a demodulation reference signal DMRS sequence in a main information block MIB specific to the first mode; carrying the information related to the signal beams related to the first mode of the base station in the content of a MIB; using SSB time domain and/or frequency domain resource locations specific to the first mode.

In an implementation, wherein the specific common search space CSS and/or the specific control resource set CORESET comprise at least one of: a CSS/CORESET specific to the first mode; a DCI format specific to the first mode, wherein the DCI carries the information related to the signal beams related to the first mode of the base station; an existing DCI format carrying the information related to the signal beams related to the first mode of the base station in the reserved bit field, a DCI format carrying a DL grant, wherein the PDSCH corresponding to the DL grant comprises the information related to the signal beams related to the first mode, the PDCCH and/or PDSCH corresponding to at least one of a msg2, a msgB and a msg4 in random access procedure, and/or the PDCCH scheduling the msg3 retransmission relates to at least one of: the reserved bit field in the DCI format of the PDCCH corresponding to at least one of the msg2, the msgB and the msg4 and/or the PDCCH scheduling the msg3 retransmission carries the information related to the signal beams related to the first mode; the MAC subheader in the PDSCH of the msg2 or msgB carries the information related to the signal beams related to the first mode; the RAR in the PDSCH of the msg2 or msgB carries the information related to the signal beams related to the first mode.

In an implementation, wherein the PDSCH corresponding to the DL grant includes a PDSCH specific to the first mode or a system information block SIB specific to the first mode.

In an implementation, wherein information related to the signal beams related to the first mode is indicated to the UE under a first condition, wherein the first condition comprises at least one of: an aggregation level of a search space of the UE satisfying a first threshold; the base station entering the first mode; an indication to initiate the first mode being transmitted to the UE; the beam selected by the UE being adjusted or changed, wherein the selected beam includes the preferred beam that the UE has reported to the base station.

According to an embodiment of the disclosure, a communication device including a transceiver and a processor coupled with the transceiver and configured to implement any method or combination of methods according to embodiments of the disclosure is provided. In an implementation, the communication device may be a user equipment (UE). In an implementation, the communication device may be a base station device. It should be understood that the communication device can also be other devices used for communication in the communication system.

### Advantageous Effects of Invention

According to various embodiments of the disclosure, transmitting and receiving beam information in a wireless communication system can be efficiently enhanced.

### BRIEF DESCRIPTION OF DRAWINGS

FIG. 1 illustrates an example wireless network according to various embodiments of the disclosure;

FIG. 2A illustrates example wireless transmission and reception paths according to the disclosure;

FIG. 2B illustrates example wireless transmission and reception paths according to the disclosure;

FIG. 3A illustrates an example user equipment according to the disclosure;

FIG. 3B illustrates an example base station according to the disclosure;

FIG. 4 illustrates a schematic diagram of representing change information of beam configuration using a muting pattern according to embodiments of the disclosure;

FIG. 5 illustrates a schematic diagram of applying first delay configuration information to a PUSCH according to embodiments of the disclosure;

FIG. 6 illustrates a schematic diagram of applying first delay configuration information to a PUCCH according to embodiments of the disclosure;

FIG. 7 illustrates a schematic simplified block diagram of a communication device according to embodiments of the disclosure;

FIG. 8 illustrates a block diagram of a terminal (or a user equipment (UE)), according to embodiments of the present disclosure; and

FIG. 9 illustrates a block diagram of a base station (BS), according to embodiments of the present disclosure.

### BEST MODE FOR CARRYING OUT THE INVENTION

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

5G communication systems are implemented in higher frequency (mmWave) bands, e.g., 60 GHz bands to achieve a higher data rate. In order to reduce propagation loss of radio waves and increase transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The following description with reference to the drawings is provided to facilitate a comprehensive understanding of various embodiments of the disclosure defined by the claims and their equivalents. This description includes various specific details to facilitate understanding but should only be considered as exemplary. Therefore, those skilled in the art will recognize that various changes and modifications can be made to various embodiments described herein without departing from the scope and spirit of the disclosure. In addition, for the sake of clarity and conciseness, description of well-known functions and structures may be omitted.

The terms and expressions used in the following specification and claims are not limited to their dictionary meanings, but are only used by the inventors to enable a clear and consistent understanding of the disclosure. Therefore, it should be obvious to those skilled in the art that the following description of various embodiments of the disclosure are provided for illustration purposes only and are not intended to limit the purposes of the disclosure as defined in the appended claims and their equivalents.

It should be understood that singular forms of “a”, “an” and “the” include plural referents unless the context clearly indicates otherwise. Thus, for example, a reference to a “component surface” includes a reference to one or more such surfaces.

The terms “include” or “may include” refer to the existence of corresponding disclosed functions, operations or components that may be used in various embodiments of the disclosure, without limiting the existence of one or more additional functions, operations or features. In addition, the terms “include” or “have” can be interpreted as indicating certain characteristics, numbers, steps, operations, constituent clements, components or combinations thereof, but should not be interpreted as excluding the possibility of the existence of one or more other characteristics, numbers, steps, operations, constituent elements, components or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in this disclosure have the same meaning understood by those understood by those skilled in the art as described in this disclosure. General terms, as defined in dictionaries, are interpreted as having meanings consistent with the context in the relevant technical fields, and should not be interpreted in an idealized or overly formal way unless explicitly defined in this disclosure.

Technical solutions of embodiments of the present application may be applied to various communication systems, such as Global System for Mobile Communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5th generation (5G) system or new radio (NR), etc. In addition, technical solutions of embodiments of the application may be applied to future-oriented communication technologies.

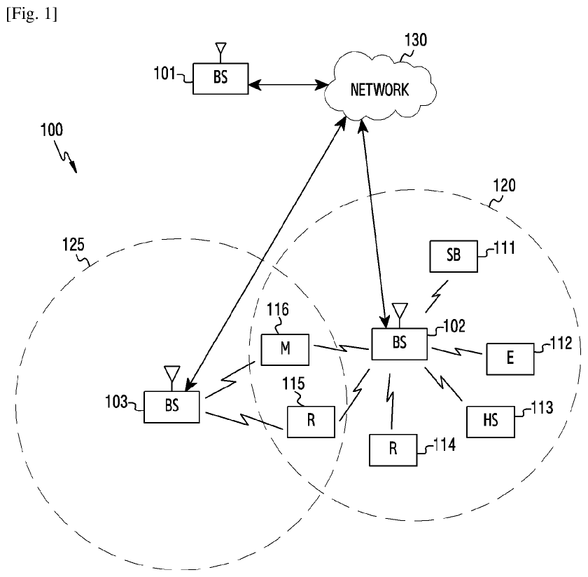

FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

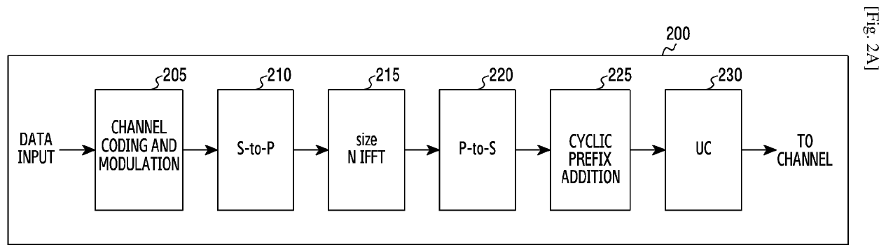

FIGS. 2A and 2B illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in conFIGurable hardware or a combination of software and conFIGurable hardware. For example, the FFT block 270 and IFFT block 215 may be implemented as conFIGurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

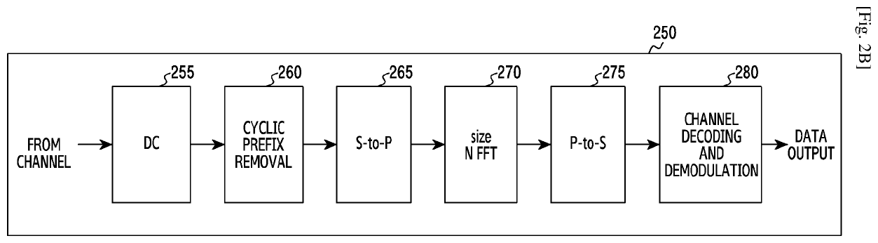

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactivated video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and perform an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in em-bodiments of the disclosure. The processor/controller 340 can move data into or out of the memory 360 as required by an execution process. In some embodiments, the processor/controller 340 is configured to perform the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by the UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactivated video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of indication, such as the BIS algorithm, are stored in the memory. The plurality of indication are configured to cause the controller/processor 378 to perform the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also called a time unit) in the present application may be: an OFDM symbol, an OFDM symbol group (composed of multiple OFDM symbols), a time slot, a time slot group (composed of multiple time slots), a subframe, a subframe group (composed of multiple subframes), a system frame, and a system frame group (composed of multiple system frames); it may also be an absolute time unit, such as 1 millisecond, 1 second, etc.; the time unit may also be a combination of various granularities, such as N1 time slots plus N2 OFDM symbols.

A frequency domain unit (also called a frequency unit) in the present application may be: a subcarrier, a subcarrier group (composed of multiple subcarriers), a resource block (RB) (also called a physical resource block (PRB)), a resource block group (composed of multiple RBs), a bandwidth part (BWP), a bandwidth part group (composed of multiple BWPs), a band/carrier, and a band/carrier group; it may also be an absolute frequency domain unit, such as 1 Hz, 1 kHz, etc.; the frequency domain unit can also be a combination of multiple granularities, such as M1 PRBs plus M2 subcarriers.

Exemplary embodiments of the disclosure are further described below with reference to the accompanying drawings.

Text and drawings are provided as examples only to help readers understand the disclosure. They are not intended and should not be construed to limit the scope of the disclosure in any way. Although certain embodiments and examples have been provided, based on the disclosure herein, it is obvious to those skilled in the art that changes can be made to the illustrated embodiments and examples without departing from the scope of this disclosure.

It can be understood by those skilled in the art that the singular forms “a”, “an”, “the” and “the” used herein can also include plural forms unless specifically stated. It should be further understood that the word “comprising” used in the specification of this application refers to the presence of said features, integers, steps, operations, elements and/or components, but does not exclude the presence or addition of one or more other features, integers, steps, operations, elements, components and/or groups thereof. It should be understood that when we say that an element is “connected” or “coupled” to another element, it can be directly connected or coupled to the other element, or intervening elements may also exist. Furthermore, “connected” or “coupled” as used herein may include wireless connection or wireless coupling. As used herein, the phrase “and/or” includes all or any unit and all combinations of one or more associated listed items.

It can be understood by those skilled in the art that unless otherwise defined, all terms (including technical terms and scientific terms) used herein have the same meaning as commonly understood by those skilled in the art to which this application belongs. It should also be understood that terms, such as those defined in general dictionaries, should be understood to have meanings consistent with those in the context of the prior art, and would not be interpreted in an idealized or overly formal sense unless they are specifically defined as herc.

It can be understood by those skilled in the art that the “terminal” and “terminal device” used herein include both a device of a wireless signal receiver, which only has a means of the wireless signal receiver without transmission capability, and a device of a reception and transmission hardware, which has a means of the reception and transmission hardware capable of bidirectional communication on bidirectional communication links. Such devices may include a cellular or other communication devices having a single-line display or a multi-line display or a cellular or other communication devices without a multi-line display; Personal Communications Service (PCS), which may combine voice, data processing, fax and/or data communication capabilities; Personal Digital Assistant (PDA), which may include a radio frequency receiver, a pager, an Internet/Intranet access, a web browser, a notepad, a calendar and/or a Global Positioning System (GPS) receiver; a conventional laptop and/or palmtop computer or other devices having and/or including a radio frequency receiver. The “terminal” and “terminal device” used herein may be portable, transportable, installed in vehicles (air, marine and/or land), or suitable and/or configured to operate locally, and/or operate in any other location on earth and/or space in a distributed form. The “terminal” and “terminal device” used herein may also be communication terminals, internet terminals and music/video playing terminals, such as PDA, Mobile Internet Device (MID) and/or mobile phones with music/video playing functions, as well as smart TVs, set-top boxes and other devices.

Without departing from the scope of the disclosure, the term “send” in the disclosure may be used interchangeably with “transmit”, “report” and “notify”.

Text and drawings are provided as examples only to help readers understand the disclosure. They are not intended and should not be construed to limit the scope of the disclosure in any way. Although certain embodiments and examples have been provided, based on the disclosure herein, it is obvious to those skilled in the art that changes can be made to the illustrated embodiments and examples without departing from the scope of this disclosure.

Transmission links of the wireless communication system mainly includes: a downlink communication link from a 5G gNB to a User Equipment, UE) and an uplink communication link from the UE to a network.

Nodes used for positioning measurement in the wireless communication system, such as the current wireless communication system, include: a UE initiating positioning request message, a Location Management Function (LMF) used for UE positioning and positioning assistance data distribution, a gNB or a transmission-reception point (TRP) broadcasting positioning assistance data and performing uplink positioning measurement, and a UE used for downlink positioning measurement. In addition, methods of the disclosure can also be extended to other communication systems, such as automobile communication (V2X), that is, sidelink communication, in which the transmission-reception point or the UE may be any device in the V2X.

With rapid development of information industry, especially increasing demand from mobile Internet and Internet of Things (IoT), unprecedented challenges to the future mobile communication technologies occur. With massive IoT devices gradually infiltrating into the mobile communication network, the number of connected devices will be even more amazing. In order to meet the unprecedented challenges, the communication industry and academia have launched extensive research on the fifth-generation mobile communication technologies (5G) to face the 2020s. At present, framework and overall goals of the future 5G have been discussed in ITU's report ITU-R M. [IMT. VISION], in which the demand outlook, application scenarios and various important performance indicators of 5G are explained in detail. In view of new demands in 5G, ITU's report ITU-R M. [IMT.FUTURE TECHNOLOGY TRENDS] provides information on technical trends of 5G, aiming at solving obvious problems such as significant improvement of system throughput, consistency of user experience, scalability to support IoT, time delay, energy efficiency, cost, network flexibility, support of emerging services and flexible spectrum utilization. In 3rd Generation Partnership Project (3GPP), the first phase of 5G is already in progress. In order to support more flexible scheduling, 3GPP decided to support variable hybrid automatic repeat request-acknowledgement (HARQ-ACK) feedback delay in 5G. In the existing Long Term Evolution (LTE) system, time from the reception of downlink data to the uplink transmission of HARQ-ACK is fixed, for example, in the Frequency Division Duplex (FDD) system, the time delay is 4 subframes. In the Time Division Duplex (TDD) system, according to uplink and downlink configuration, the HARQ-ACK feedback time delay is determined for the repective downlink subframe. In the 5G system, whether it's the FDD or TDD system, for a determined downlink time unit (for example, a downlink time slot or a downlink mini-slot), an uplink time unit that may feedback HARQ-ACK is variable. For example, the time delay of HARQ-ACK feedback may be dynamically indicated by physical layer signaling, and different HARQ-ACK time delays may also be determined according to different services or user capabilities.

3GPP defines three directions of 5G application scenarios-enhanced mobile broadband (eMBB), massive machine-type communication (mMTC) and ultra-reliable and low-latency communication (URLLC). An eMBB scenario aims to further improve data transmission rate based on the existing mobile broadband service scenario, so as to enhance the user experience and pursue the ultimate communication experience between human. mMTC and URLLC are for application scenarios such as the Internet of Things, but with respective different emphases: mMTC aims mainly at information interaction between human and things, and URLLC mainly reflects communication needs between things.

In 5G NR, due to the introduction of larger bandwidth and higher frequency band, the energy consumption of the base station is several times of that of a LTE base station. Therefore, how to reduce the energy consumption of the base station is a problem to be solved. In actual deployment, high-power consumption of a NR base station greatly increases the operating cost of operators, so it is very important to improve the power efficiency of the base station so that the base station can reduce energy consumption. However, while reducing the energy consumption of the base station, for example, by reducing the number of antenna elements of the transmission antenna array or directly reducing the number of transmititng beams, how to reduce the influence of reducing the energy consumption of the base station on the network performance is a problem that needs to be solved.

In order to solve at least the above problems, the disclosure provides a transmitting method, a receiving method, and a device for beam information. The method comprises: a UE obtains information related to the adjustment of signal beam by a base station, and after obtaining the information related to the adjustment of the signal beam by the base station, the UE performs corresponding operations, so that the UE may better adapt to the adjustment of the signal beam by the base station, thereby reducing the influence on system performance caused by the adjustment of the signal beam by the base station.

The base station may directly transmit information related to signal beam adjustment to the UE, or may implicitly indicate the information related to the signal beam adjustment to the UE. For example, by changing the sequence used to transmit a signal, or changing time domain and/or frequency domain resources used to transmit the signal, or transmitting the signal in a different way, etc., the base station can indicate to the UE that the base station operates in a specific mode in which the base station will adjust the beam of the signal (for example, change the beam, turn off part or all of the beams, etc.). Alternatively, the base station transmits beam adjustment related information to the UE under certain conditions, or the base station only transmits the beam adjustment related information to the UE satisfying certain conditions.

In this description, a signal beam involved may be a signal or a signal-related beam such as a SSB, a CSI-RS and/or a PRS and the like, and for convenience of description, description such as “beam”, “beam signal” and “signal beam” are used, but it can be understood that these description may all be replaced by a signal such as a SSB, a CSI-RS and/or a PRS, and the like, and these beams will be adjusted or changed when the base station operates in a specific mode to satisfy specific requirements of the base station, such as power control and energy saving. Therefore, it can be understood that in this disclosure, the adjustment of a beam not only involve the adjustment of the actual physical beam (for example, the boresight direction and beam width of the beam, etc.), but in some cases, also involve the adjustment of the signal (for example, changing the sequence of the signal, etc.). In addition, although SSB is used as an example in some description, it can be understood that this is only an example, and the description is equally applicable to other signal beams, such as the beams related to signals such as CSI-RS, PRS and the like.

It should be understood that methods described in the application may be applied to various scenarios in which the base station adjusts the beam, for example, including but not limited to the base station operating in an energy-saving mode, the base station operating in reduced capability (redcap) mode, and the base station operating in small data transmission (SDT) mode, and the like. In the following description, for brevity, the methods of the disclosure will be described by taking the operation of the base station being in the energy-saving mode as an example. It can be understood that the following description is also applicable to scenarios where the base station operates in other modes involving beam adjustment or power reduction.

In one embodiment of the disclosure, the methods proposed by the disclosure are introduced to perform the transmission and reception operations related to energy saving indication of the base station in initial access related process. The base station may enter the energy-saving mode based on various reasons, such as power control, energy-saving requirements, etc., in the energy-saving mode, the base station may adjust an antenna array, resulting in change of the transmit beams, which are called the adjusted beams in the disclosure; for example, when the antenna elements in the antenna array are partially turned off, the transmit beams of the base station device may become wider, the coverage angle becomes larger, but the antenna gain becomes smaller; in particular, if the antenna array is turned off as a whole (for example, all antenna elements are turned off), the transmit beams of the base station device are completely turned off. In some cases, the base station device may adopt the above adjustment for one or some or all of the beams. In addition, when the base station device operates in the energy-saving mode, the beam adjustment may be relatively dynamic, so the UE needs to know information about the adjustment of signal beams (for example, the beam of signals such as Synchronization Signal Block (SSB), channel state information reference signal (CSI-RS) and/or positioning reference signal (PRS) signal), so that some corresponding operations for the adjusted beams can be performed.

In the process related to initial access, the UE may perform downlink signal (such as SSB/CSI-RS/PRS signal) measurement and may also perform random access procedure. Therefore, the adjustment of the beam at the base station side may have an influence on various operations in the process related to initial access, such as reducing the reception performance of the downlink signal. In addition, the change of the beam at the base station side may also lead to the change of path transmission between the base station and the UE, so the path loss information obtained by previous measurement is inaccurate, which leads to the inaccuracy of uplink signal transmission power.

Through the transmitting and/or receiving method for beam information provided by the disclosure, the base station device and the UE device can communicate the information related to the signal beam adjustment (or called information related to the signal beam related to a first mode of the base station), and the UE can perform some corresponding operations on beam adjustment. In the disclosure, the signal beam may include the beam of SSB, CSI-RS and/or PRS signal, so expressions related to “signal beam” or “beam” or “beam signal” may be replaced by SSB, CSI-RS and/or PRS, for example, “pattern of adjusted beams” or “pattern of adjusted signal beams” or “pattern of adjusted beam signals” may be for example replaced by “pattern of adjusted SSBs”. It should also be understood that although methods are illustrated by taking network energy saving as an example, the methods proposed by the disclosure are not only applicable to the case of network energy saving mode, but also applicable to any other situation that causes the base station to adjust the beam or antenna, such as reduced capacity (redcap), small data transmission (SDT), and so on.

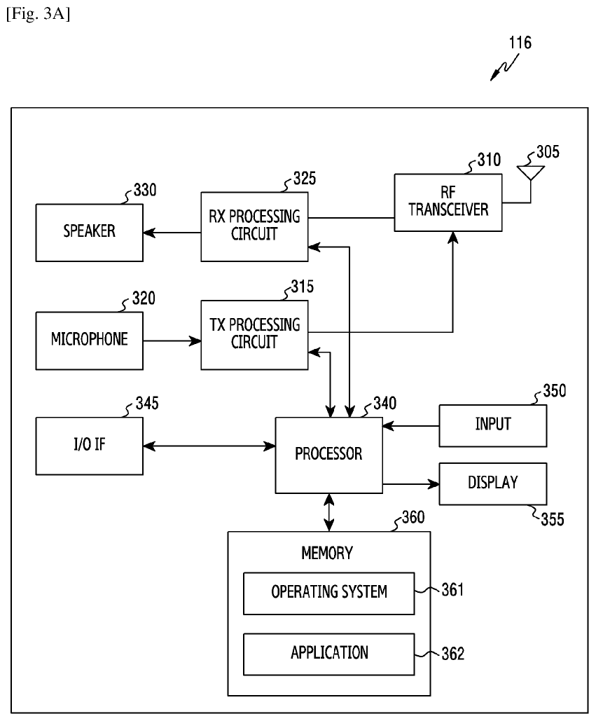

According to embodiments of the disclosure, the UE can obtain the information related to the signal beam adjustment of the base station device in a certain way, or the base station can indicate the information related to the signal beam adjustment to the UE in a certain way;

Wherein, the information related to the signal beam adjustment includes one or more of:
A pattern of the adjusted beams, that is, the UE can obtain index information of beams transmitted in a period through the pattern information; in particular, the pattern may further include
   The number of time units of the period of the adjusted signal beams, and/or
   The number of time units occupied by the adjusted signal beams in a period; and/or
   The information on the number and/or location index of beams in a period after adjustment; and/or
change information as compared with the previous beam configuration, the change information can indicate the information of the changed (for example, adjusted) beams relative to the existing beam pattern; for example, the change information may be a muting pattern or a mask pattern (a mask index, or a mask). Taking the muting pattern being a bitmap as an example, for example, when the base station device transmitted 8 SSBs originally, if the muting pattern indicated by the change information is 11001100, in which “1” represents that the SSB at the corresponding location is not muted, as shown in SSBs 0, 1, 4 and 5 in FIG. 4; and “0” represents that the SSB at the corresponding location is muted, as shown in SSBs 2, 3, 6 and 7 in FIG. 4, that is, the muting pattern can indicate to UE that SSBs 2, 3, 6 and 7 are turned off.
A first pattern of the antenna array, for example, the base station device uses an array of 16*16=256 antenna elements, and the base station device identifies the antenna elements that are turned off as 0 and the antenna elements that are not turned off as 1 among the 16*16 antenna elements, and informs the UE of information of matrix of 16*16; the UE obtains this information and get the change situation of the antenna elements of the base station, and then know the possible beam direction and/or scope; and/or;
codebook information (such as a codebook index) of antenna transmission coefficients for MIMO transmission; and/or;
Boresight direction information and/or beam width information corresponding to a beam; and/or;
A flag for occurrence of adjustment and/or initiation of energy-saving mode, such as a 1-bit flag, indicating whether the energy-saving mode is initiated or whether the beam configuration is changed; if “1” indicates that the energy-saving mode is initiated or the beam configuration is adjusted, the UE uses pre-configured or obtained beam configuration used in the energy-saving mode or uses the adjusted beam configuration; for example, the information related to the pre-configured or obtained beam configuration or the adjusted beam configuration can be transmitted to the UE by the base station in advance.

Wherein, the certain way includes a combination of one or more of:
By adjusting or configuring or reconfiguring the beam signal (such as SSB, CSI-RS, PRS, etc.), taking SSB as an example, wherein the adjusting includes a com-bination of one or more of:
   Using a different sequence, such as the sequence specific to the first mode (e.g., network energy saving mode), such as the sequence different from or even orthogonal to the previous Primary Synchronization Signal (PSS) and/or Secondary Synchronization Signal (SSS); in one implementation, in the first mode, the base station uses a first sequence to transmit the SSB, the first sequence is different from a second sequence used by the base station to transmit the SSB in a non-first mode (or the second mode, or when the first mode is not activated); thus, by receiving the SSB with the first sequence, the UE can know that the base station used the first mode, and optionally, the UE can also know which beams the base station used or turned off or how the base station adjusted or changed the beams;
   Using a different DMRS sequence in the Master Information Block (MIB), for example, using the DMRS sequence in MIB specific to the first mode, for example, using the sequence different from or orthogonal to the previous DMRS sequence; in one implementation, in the first mode, the base station uses a first DMRS sequence to transmit the SSB, the first DMRS sequence is different from a second DMRS sequence used by the base station to transmit the SSB in the non-first mode; thus, by receiving the first DMRS sequence, the UE can know that the base station used the first mode, and optionally, the UE can also know which beams the base station used or turned off or how the base station adjusted or changed the beams.
   In the content of MIBs, especially, only the bits in MIBs that do not need to be coded carry the information related to SSB beam adjustment; which may not affect the combining operation of MIBs performed by the UE;
   Using different SSB time domain and/or frequency domain resource locations, for example, using the SSB time domain and/or frequency domain resource locations specific to the first mode; in one implementation, in the first mode, the base station uses first time domain and/or frequency domain resource locations to transmit SSB, the first time domain and/or frequency domain resource locations are different from second time domain and/or frequency domain resource locations used by the base station to transmit SSB in the non-first mode; thus, based on the detection of SSBs in different time domain and/or frequency domain resource locations, the UE can also obtain the information related to beam adjustment of the base station;
Through a specific common search space (CSS) and/or a specific control resource set (CORESET), specifically, one or more of the following can be included:
   Through the CSS/CORESET specially applied to the first mode (e.g., the network energy saving mode), such as type 0A CSS, in particular, in order to search for a PDCCH in the CSS and/or CORESET, the UE can use a specially configured RNTI, such as NWES-RNTI; wherein, the first mode is related to the adjustment of the signal beams by the base station, and in addition to the energy-saving mode, the first mode can also be reduced capacity (redcap), Small data transmission (SDT) or other modes.
   Through the DCI format specially applied to the first mode (for example, the network energy saving mode), such as a new DCI format (for example, DCI 2-N, etc.), wherein the DCI carries the information related to the signal beam adjustment;
   Carrying the information related to beam adjustment by using the spare bit or reserved bit in the existing DCI format;
   In one implementation, the scheduling of DL grant can be carried in the DCI, and the UE can find the scheduled PDSCH through this DL grant, so as to obtain the information related to the signal beam adjustment in the PDSCH; in one implementation, the scheduled PDSCH found through the DL grant may be a PDSCH specific to the first mode (e.g., network energy saving mode); alternatively, the PDSCH may also be a system information block SIB specific to the first mode (e.g., network energy saving mode);
Through msg2 (including PDCCH and/or PDSCH) and/or msgB (including PDCCH and/or PDSCH) and/or the PDCCH scheduling retransmission of msg3 and/or msg4 (including PDCCH and/or PDSCH) in random access procedure, and specifically includes one or more of:
   The spare bit or reserved bit in the DCI format in the PDCCH of msg2 or msgB carries the information related to the signal beam adjustment; considering that the UE uses RA-RNTI and/or msgB-RNTI to search for the PDCCH of msg2 or msgB, and the values of RA-RNTI and/or msgB-RNTI are related to the time-frequency resource location where a RACH occasion (RO) used by the UE for random access is located (that is, different Ros correspond to different RA-RNTI and/or msgB-RNTI), and there may be multiple Ues making random access attempts using the same RO, therefore, in the case of a beam signal (for example, a SSB) is adjusted, all Ues that selected the RO corresponding to and mapped to the beam signal to transmit the preamble can obtain an indication, which can save the signaling overhead for transmitting the indication to all these Ues.
   The spare bit or reserved bit in (the DCI in) the PDCCH format of msg3 or msg4 carries the information related to the signal beam adjustment;
   The MAC subheader in the PDSCH of msg2 or msgB carries the information related to the signal beam adjustment, wherein the MAC subheader can be the reserved bit in the existing MAC subheader and/or the MAC subheader specially applied to the first mode (for example, the network energy saving mode); this method is also beneficial to inform multiple Ues of information related to the beam adjustment, thus saving the signaling overhead;
   The RAR in the PDSCH of msg2 or msgB (including the RAR of msg2 and/or the successful RAR and/or fallback RAR of msgB) carries the information related to the signal beam adjustment, which is suitable for indication for a particular affected UE.

In one implementation, the UE obtains the information related to the signal beam adjustment of the base station device in the above-mentioned certain way only when a first condition is satisfied, that is, the base station indicates the information related to the signal beam adjustment to the UE in the above-mentioned certain way only when the first condition is satisfied, or only the UE satisfying the first condition obtains the information related to the signal beam adjustment of the base station device in the above-mentioned certain way, or the base station only indicate the information related to the signal beam adjustment to the UE satisfying the first condition in the above-mentioned certain way, the first condition may be a combination of one or more of:
When the aggregation level of the search space obtained by the UE satisfies a certain condition (for example, being the minimum aggregation level, such as AL0, and/or less than (not greater than) a certain level value, such as the aggregation level of less than (not greater than) 8); this condition is suitable for the following case: even if the corresponding beam is adjusted (for example, weakened), if the aggregation level is large enough to satisfy the coverage of the UE, the UE does not need to know about the beam adjustment or perform corresponding operations on the beam adjustment;
When a serving gNB of the UE enters the first mode (for example, the energy-saving mode); specifically, including the UE receives an indication of the initiation of the first mode of the base station;
When the beam selected by the UE is adjusted; the selected beam includes the preferred beam previously reported by the UE to the base station;

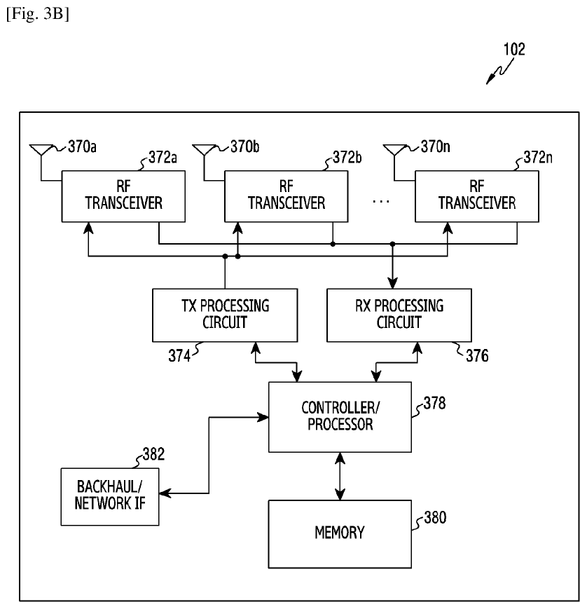

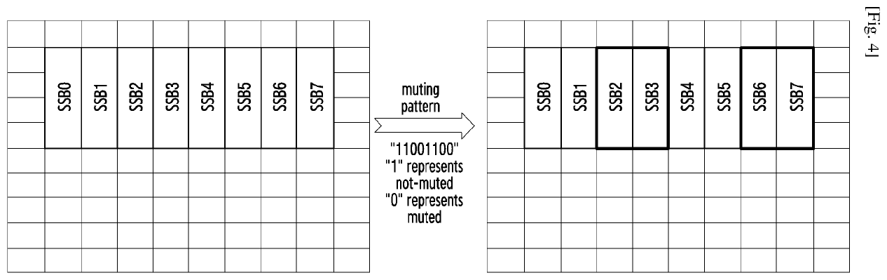

In one implementation, after obtaining, by the UE, the information related to the signal beam adjustment, the UE performs a first operation, which may be a combination of one or more of:
Measuring the signal beams after adjustment and reporting the measurement result and/or the preferred beam index; for example, transmitting a CSI report to the base station;
   In one implementation, the UE reports the preferred beam index through a PRACH, or msg3 PUSCH and msgA PUSCH;
   In one implementation, if the UE is in a connected state, the preferred beam index can be reported through the PUSCH or the PUCCH;
Determining whether the resource corresponding to the beam index of the signal beam is valid or available based on whether the signal beam is turned off after adjustment.
   In one implementation, if the beam is turned off after adjustment, the UE considers that the RACH resource (RO and/or preamble) corresponding to the beam index is unavailable or invalid;
   In one implementation, if the beam is changed (for example, the beam is widened due to the reduction of antenna elements, or the direction is changed, etc.) after the adjustment, the UE considers that the RACH resource (RO and/or preamble) corresponding to the beam index is still available or valid;
The UE receives the first delay configuration information transmitted by the base station for the scheduled uplink signal, and the first delay configuration information is related to the adjustment of beams by the base station, wherein
   The UE receives first delay configuration information for uplink transmission scheduled by RAR UL grant carried by the base station through RAR or RAR UL grant of msg2; and/or
   The UE receives first delay configuration information for uplink transmission for msg3 retransmission scheduled by the base station through DCI UL grant carried by the PDCCH corresponding to msg3; and/or
   The UE receives first delay configuration information for uplink transmission of the PUCCH corresponding to the PDSCH carried by the base station through msg4 PDCCH and/or PDSCH; and/or
   The first delay configuration information includes N time units (N is a positive integer), that is, the UE can determine the uplink transmission timing according to the time interval information in time domain resource configuration and/or the first delay configuration information. Optionally, the N time units may be pre-configured or dynamically configured by RRC/DCI. For example, as shown in FIG. 5, the DCI schedules a PUSCH transmission, because the UE receives the first delay configuration information, delay is performed by additionally using the number of time units obtained through the first delay configuration information on top of the time domain interval originally configured in TDRA, to obtain the actual resource location of the PUSCH. In addition, for example, as shown in FIG. 6, the DCI schedules a PDSCH, and the UE needs to feedback the PUCCH (carrying ACK/NACK information) after receiving the PDSCH, and the resource location of the PUCCH is outside the time domain interval of the original resource configuration, delay is performed by additionally using the number of time units obtained through the first delay configuration information to obtain the actual resource location of the PUCCH.

The UE may obtain a backoff indication through random access msg2 or msgB, and the backoff indication may indicate that the UE needs to retransmit msg1 or msgA at least after M (M is a positive integer) time units; in one implementation, the backoff indication includes a random backoff indication and/or a pre-configured backoff indication and/or a fixed backoff indication and/or a backoff indication satisfying a certain size of the number of time units. In this way, the UE may perform uplink transmission according to the backoff indication and by using the first delay configuration information received from the base station, which is beneficial for the UE to have sufficient time to re-obtain the preferred beam index;
The UE obtains the indication of transmit beam index of the PDCCH indicated by the base station from the PDCCH and/or PDSCH in the obtained message 4, the transmit beam index includes the transmit beam index corresponding to the corresponding downlink beam index; which is suitable for the case where the beams are adjusted before transmitting the PUCCH;
The UE extends and/or stops (resets) and/or pauses and/or restarts the contention resolution timer in random access procedure; for example, when beam adjustment occurs in the process of transmitting msg3, it is necessary to introduce extra time for the UE to re-measure and/or re-obtain the preferred beam index information;

In one implementation, the UE performing the first operation after obtaining the information related to the signal beam adjustment further includes performing the first operation after a period of time after receiving the information related to the signal beam adjustment; the period of time includes K (K is a positive integer) time units, which can be pre-configured (for example, via higher-layer RRC signaling) and/or fixed and/or dynamically configured (for example, via DCI and/or MAC CE signaling).

In another embodiment of the disclosure, in supporting the transmission of the uplink data signal, for example, in the scenario of small data transmission (SDT), the UE may be allowed to transmit the data signal without fully accessing the system and being in the connected state. In this embodiment, a resource confirmation method and a transmission method of the uplink data signal are proposed, so that the UE can obtain the mapping relationship between the pre-configured uplink transmission resources and the downlink beams through the methods provided by the disclosure, and when the uplink data signal needs to be transmitted, the UE can determine the corresponding uplink transmission resources to transmit the uplink data signal according to the selected downlink beam. The methods provided by the disclosure can be used not only for SDT scenario, but also for uplink data signal transmission in other scenarios; the following is an exemplary description of the methods by taking the uplink data signal transmission of SDT as an example. The SDT is divided into configured grant-based SDT (CG-SDT) and random access-based SDT (RA-SDT).

In the case of configured grant-based SDT (CG-SDT) transmission, the UE may obtain configuration information for one or more CG-PUSCHs of CG-SDT transmission from the base station device, wherein the configuration information for the CG-PUSCHs includes one or more of:
The transmission resource size (such as the number of occupied time units and/or frequency domain units) and the location (such as the starting time unit location in a time slot) of a PUSCH:
The DMRS resource configuration of a PUSCH, including DMRS sequence index and/or DMRS port index;
The size of periodicity of a CG-PUSCH;
The number of transmission resources for the PUSCH in a CG-PUSCH period (including the number in time domain and/or the number in frequency domain), optionally, the number of transmission resources for the PUSCH in a period may be determined by the configured number of repetitions, wherein the number of repetitions may be the number of repetitions in repetition type A and/or the number of nominal repetitions and/or the number of actual repetitions in repetition type B; that is, the number of repetitions is the number of transmission resources actually configured; which may increase available PUSCH resources.
The downlink signal set with which the resources for the CG-PUSCH is associated, that is, one downlink signal or a group of downlink signals (for example, SSB and/or CSI-RS, in the present invention, SSB is used as an example, but it can be replaced by CSI-RS);
   Particularly, when the UE does not obtain the indication of an SSB or a group of SSBs (that is, the indication is absent), the UE may:
      Use the SSB index configured in the system broadcast message of the base station device (for example, ssb-PositionsInBurst) as the associated SSB or the group of associated SSBs; particularly, the system broadcast message of the base station device may be the system broadcast message read by the UE before entering RRC_INACTIVE, or the latest system broadcast message read by the UE (before performing SDT); and/or
      Map the SSB indexes in the system broadcast message to configured CG-PUSCHs in sequential order, including:
Mapping the SSB indexes to one or more PUSCH resources in a CG-PUSCH sequentially, for example, using SSBs 0, 1, 2 and 3 in total; a CG-PUSCH configuration includes four PUSCH transmission resources, so SSB0 is mapped to PUSCH transmission resource 0, SSB1 is mapped to PUSCH transmission resource 1, SSB2 is mapped to PUSCH transmission resource 2, and SSB3 is mapped to PUSCH transmission resource 3, specially, the index order of the PUSCH resources is implemented with frequency domain first, then time domain; or time domain first, then frequency domain; the number of the PUSCH transmission resources may be replaced by the number of PUSCH DMRS resources and/or the number of PUSCH transmission units (including a PUSCH transmission resource and a DMRS); or
Mapping the SSB indexes to a plurality of CG-PUSCH configurations sequentially, for example, using SSB0,1,2,3 in total; there are four CG-PUSCH configurations in total, so SSB0 is mapped to the first CG-PUSCH configuration, SSB1 is mapped to the second CG-PUSCH configuration, SSB2 is mapped to the third CG-PUSCH configuration, and SSB3 is mapped to the fourth CG-PUSCH configuration;
   Preferably, in the associated SSB indication, the associated SSBs can be configured explicitly with the PUSCH transmission resources mapped by the associated SSB, such as four PUSCH transmission resources (PUSCH0, 1, 2, 3) included in a CG-PUSCH configuration, for example, PUSCH0 indicates SSB0, PUSCH 1 corresponds to SSB1, PUSCH 2 corresponds to SSB2, PUSCH 3 corresponds to SSB3, wherein the corresponding SSBs may be the same or different, so that the SSB mapped by a PUSCH can be configured very flexibly; or through the sequential mapping of the determined associated SSB indexes, which can save signaling overhead;
The mapping ratio indication of the associated SSBs to the PUSCHs in the corresponding CG-PUSCH, that is, the information that one or more SSBs can be mapped on a PUSCH resource is obtained,
   When the UE obtains the mapping ratio indication, SSB-PUSCH mapping is performed according to the indicated mapping ratio;
   When the UE fails to obtain the above mapping ratio indication, the UE may:
      Not perform the mapping operation of SSB-PUSCH, that is, as long as the SSB selected during performing SDT is among the associated SSBs, the UE can use the corresponding CG-PUSCH resources to transmit; if there are multiple selectable PUSCH transmission resources and/or DMRS resources, the UE selects one resource for transmission randomly with equal probability; and/or
      Determine the mapping ratio value by the ratio of the number of PUSCH transmission resources in a CG-PUSCH period to the number of associated SSBs (the obtained ratio can be rounded, or the closest preset ratio not less than or greater than the obtained ratio can be found as the mapping ratio value); in particular, the number of PUSCH transmission resources can be replaced by the number of PUSCH DMRS resources and/or the number of PUSCH transmission units (including a PUSCH transmission resource and a DMRS), that is, different transmission resources or different DMRS are different PUSCH transmission units;

In the process of mapping SSBs to PUSCHs, for one or more SDT CG-PUSCH configurations (which can also be simply described as one or more PUSCH configurations with the same meaning as the previous CG-PUSCH configurations), starting from frame 0, the mapping period used to map SSB indexes to an valid PUSCH occasion and/or DMRS resources associated with the PUSCH occasion is the minimum value in the candidate value set of one or more SSB-PUSCH mapping periods that satisfies certain conditions. In addition, the mapping pattern period of an SSB-PUSCH includes one or more mapping periods, in the mapping pattern period, the mapping pattern of SSB indexes and PUSCH resources is repeated with Tmax time at most. Wherein, specifically,
The certain conditions include at least: N_{TX}^{SSB} SSBs can be mapped at least once in the valid PUSCH occasion thereof (that is, in the mapping period); wherein N_{TX}^{SSB} can be one or (more) a group of SSBs (such as ssb-PositionsInBurst) obtained from system information block 1 (SIB1) or from ServingCellConfigCommon configuration message; or obtained from one or (more) a group of SSBs in one or more corresponding SDT CG-PUSCH configurations; particularly, as described above, when one or (more) a group of SSBs are not configured in one or more SDT CG-PUSCH configurations, one or (more) a group of SSBs (for example, ssb-PositionsInBurst) from system information block 1 (SIB1) or from ServingCellConfigCommon are used again; and/or
The SSB-PUSCH mapping period may be N times of the SDT CG PUSCH configuration period (i.c., the period size of the aforementioned CG-PUSCH), where N is an integer greater than or equal to 1; and/or
The candidate value set of the SSB-PUSCH mapping periods includes: for an SDT CG PUSCH configuration period value P_{cg-sdt} (which may be an absolute time such as milliseconds, seconds, etc.; it may also be other time units such as OFDM symbols, time slots, etc.), candidate value set of its corresponding SSB-PUSCH mapping periods is {1, . . . , [P_{cg-sdt-large}/P_{cg-sdt}], . . . , Tₘₐₓ*N_{symbperslot}*2^{μ}/P_{cg-sdt}}, specifically
   Wherein P_{cg-sdt} is obtained by the UE from the SDT CG PUSCH period configuration information (such as “periodicity” and/or “periodicityext”);
   Where P_{cg-sdt-large} is one or more period values in the selactable value set of CG PUSCH period configuration that are greater than (or not less than) P_{cg-sdt};
   Wherein Tₘₐₓ is the maximum value of the configured or default SSB-PUSCH mapping period or the maximum value of the SSB-PUSCH mapping pattern period, for example, the default value is 160 ms or 640 ms;
   Wherein the N_{symbperslot} is the number of symbols in a time slot, such as N_{symbperslot}=14 for normal cyclic prefix (CP) and N_{symbperslot}=12 for extended CP;
   Wherein 2^{μ} represents subcarrier spacing indication, and μ=0, 1, 2, 3, 5, and 6 respectively represent 15 khz, 30 kHz, 60 kHz, 120 kHz, 480 KHz, and 960 kHz;
   Wherein [X] represents rounding operation on X, preferably, it may be up-rounding or down-rounding operation;
Optionally, when the UE receives the configured repetition parameters (including at least one of repetition type and the number of repetitions), take repeated PUSCHs during a certain time as a PUSCH occasion; the certain time may be the configuration period of a CG PUSCH or a SSB-PUSCH mapping ring or mapping period or mapping pattern period; when any repetition in the PUSCH occasion is invalid (that is, as long as at least one repetition is invalid), the PUSCH occasion is decided to be invalid and equivalently, that is, when all repetitions in the PUSCH occasion are valid, the PUSCH occasion is decided to be valid; optionally, when at least one or any repetition of the PUSCH occasion is valid, the PUSCH occasion is decided to be valid; equivalently, when all repetitions in the PUSCH occasion are invalid, the PUSCH occasion is decided to be invalid; optionally, only the valid PUSCH occasion is used for the mapping operation of the SSB-PUSCH; optionally, the repetition being valid means that the PUSCH time-frequency resource where the repetition is located satisfies the validity decision; the repetition being invalid means that the PUSCH time-frequency resource where the repetition is located does not satisfy the validity decision. This can ensure that a valid PUSCH occasion mapped to any SSB contains the same number of repetitions, thus ensuring fairness.

Before SDT is performed, the UE can select an SSB through downlink measurement, and the selection method can include one of (mutually replaceable) or a combination of multiple of:
According to the DL-RSRP threshold configured by the base station, if the measured SSB-RSRP is greater than the DL-RSRP threshold, the UE selects the SSB;
   If more than one SSB exceeds the threshold, then
      The UE selects the SSB with the largest RSRP value as the selected SSB; or
      The UE randomly selects an SSB from those with equal probability as the selected SSB;
The UE selects the SSB with the largest SSB-RSRP value as the selected SSB;

Preferably, when the selected SSB by the UE is not among the SSBs associated with the CG-PUSCH received by the UE, for example, the base station indicates in the CG-PUSCH configuration that the associated SSBs are SSB0 and SSB1, but the selected SSB by the UE is SSB3, the UE may perform one or more of the following operations:
The UE does not perform CG-SDT, and (switches to) perform random access-based SDT, namely RA-SDT; preferably, two-step random access SDT is performed preferentially;
The UE assumes that the selection operation of the SSB may only be performed among the associated SSBs indicated by the base station in the CG-PUSCH configuration, that is, the above selection method is applied to the associated SSB set (i.c., one or more SSBs) indicated by the base station in the CG-PUSCH configuration determined by the UE; refer to the above method for specific operations, and redundant description is not repeated;
The UE assumes that the associated SSBs indicated by the base station in the CG-PUSCH configuration includes all SSBs that the UE may measure; otherwise, the UE considers that this is a wrong situation and its behavior is undefined;

After determining the SSB and the corresponding PUSCH resources, the UE may perform the corresponding uplink data signal transmission.

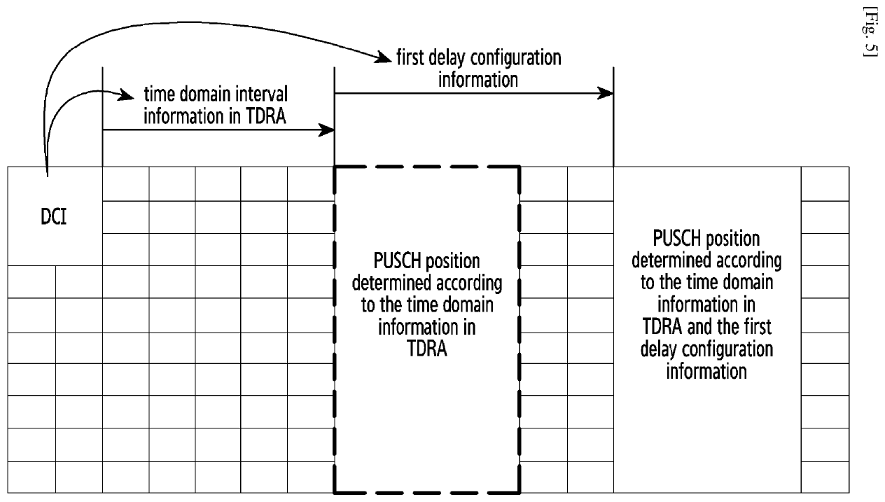

Referring to FIG. 7, the embodiment further provides a communication device (a base station or a user equipment UE) 700 for transmission or reception of the beam information. The communication device includes a memory 701, a processor 702 and a transceiver 703. The processor 702 is coupled with the transceiver 703 and the memory 701. Computer executable instructions are stored in the memory, which, when executed by the processor 702, cause at least one method corresponding to the above-mentioned embodiments of the disclosure to be performed. The above is only an exemplary embodiment of the disclosure, and is not used to limit the disclosure. Any modification, equivalent substitution, improvement, etc. made within the spirit and principle of the disclosure should be included in the scope of protection of the disclosure.

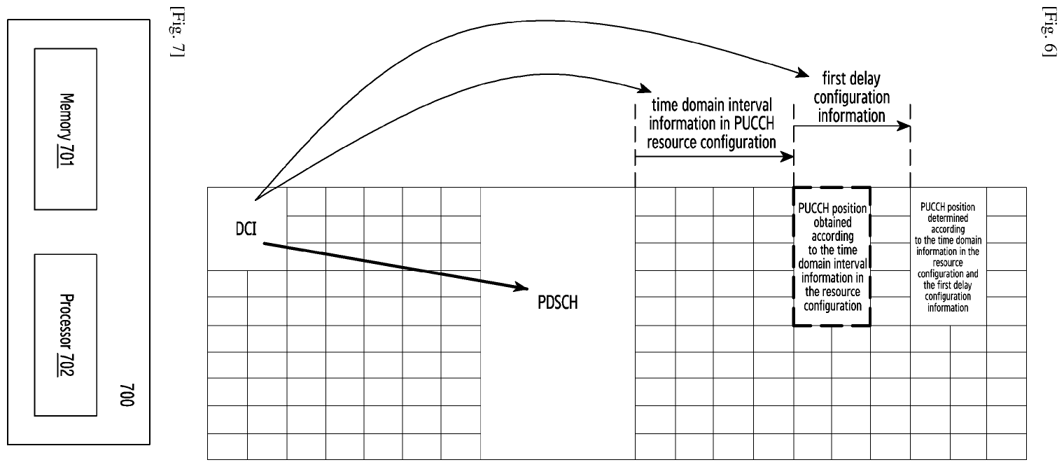

FIG. 8 is a block diagram illustrating a structure of a UE according to an embodiment of the disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE 111, UE 112, UE 113, UE 114, UE 115, or UE 116 of FIG. 1.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

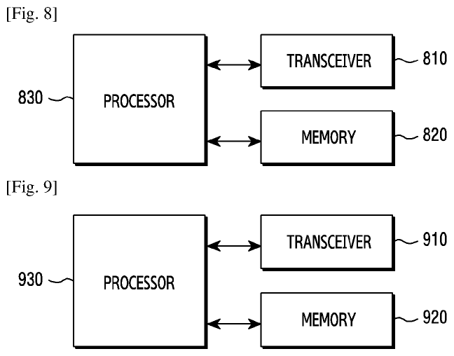

FIG. 9 a block diagram illustrating a structure of a base station according to an embodiment of the disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station of FIG. 9 corresponds to the BS (eg., gNodeB (gNB) 101, a gNB 102, and a gNB 103) of FIG. 1.

The transceiver 910 collectively refers to a base station receiver and a base station transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

Those skilled in the art may understand that the disclosure includes devices for perform one or more of the operations described in the application. These devices may be specially designed and manufactured for required purposes, or they can also include known devices in general-purpose computers. These devices have computer programs stored therein, which are selectively activated or reconfigured. Such computer programs may be stored in device (e.g., computer) readable medium including but not limited to any type of disk (including floppy disk, hard disk, optical disk, CD-ROM, and magneto-optical disk), Read-Only Memory (ROM), Random Access Memory (RAM), Erasable Programmable Read-Only Memory (EPROM), Electrically Erasable Programmable Read-Only Memory (EEPROM), flash memory, magnetic card or optical card. That is, the readable medium includes any medium in which information is stored or transmitted by a device (e.g., a computer) in a readable form.

It may be understood by those skilled in the art that each block in these structural diagrams and/or block diagrams and/or flow diagrams and combinations of blocks in these structural diagrams and/or block diagrams and/or flow diagrams may be implemented by computer program instructions. It may be understood by those skilled in the art that these computer program instructions may be provided to a processor of a general-purpose computer, a dedicated computer or other programmable data processing methods for implementation, so that the scheme specified in the block or blocks of the structural diagrams and/or block diagrams and/or flow diagrams disclosed in the disclosure may be performed by the processor of the computer or other programmable data processing methods.

Those skilled in the art may understand that the steps, measures and schemes in various operations, methods and processes discussed in the disclosure can be alternated, modified, combined or deleted. Further, other steps, measures and schemes in the various operations, methods and processes already discussed in the disclosure can also be alternated, changed, rearranged, decomposed, combined or deleted. Further, steps, measures and schemes in various operations, methods and flows disclosed in the disclosure in the prior art can also be alternated, changed, rearranged, decomposed, combined or deleted.

The above described is only part of the implementation of the disclosure. It should be pointed out that for those skilled in the art, several improvements and embellishments can be made without departing from the principles of the disclosure, and these improvements and embellishments should also be regarded as the protection scope of the disclosure.

1. A method performed by a user equipment UE, comprising:
receiving, from a base station, information related to signal beams related to a first mode of the base station; and
performing an operation related to communication based on the information related to the signal beams related to the first mode of the base station,
wherein the information related to the signal beams related to the first mode of the base station comprises at least one of:
a pattern of beams related to the first mode of the base station for indicating transmit beam index information related to the first mode of the base station;
information of the signal beams for indicating the beams related to the first mode of the base station;
a pattern of an antenna array for indicating antennas related to the first mode of the base station;
codebook information for multiple-input multiple output MIMO transmission;
boresight direction information of the beams;
beam width information;
a beam change flag for indicating whether a beam configuration is adjusted to be related to the first mode of the base station; and
information for indicating whether the first mode is initiated.

2. The method of claim 1, wherein the pattern of the beams related to the first mode of the base station further comprises at least one of:
information on the number of time units corresponding to the period of the beams related to the first mode of the base station,
information on the number of time units occupied by the beams related to the first mode of the base station in a period,
information on the number and/or location index of the beams related to the first mode of the base station in a period.

3. The method of claim 1,
wherein the information related to the signal beams related to the first mode of the base station is received through at least one of:
implicit indication of the information related to the signal beams related to the first mode of the base station; and
a specific common search space CSS and/or a specific control resource set CORESET;
the PDCCH and/or PDSCH corresponding to at least one of a msg2, a msgB and a msg4 in random access procedure, and/or the PDCCH scheduling the msg3 retransmission.

4. The method of claim 1, wherein the information related to the signal beams related to the first mode of the base station is received from the base station under a first condition,
wherein the first condition comprises at least one of:
an aggregation level of a search space of the UE satisfying a first threshold;
a serving base station of the UE entering the first mode;
the UE receiving an indication that the base station initiates the first mode;
the selected beam by the UE being adjusted or changed, wherein the selected beam comprises a preferred beam that the UE has reported to the base station.

5. A method performed by a base station BS in a communication system, comprising:
transmitting, to a user equipment UE, information related to signal beams related to a first mode,
wherein the information related to the signal beams related to the first mode comprises at least one of:
a pattern of beams related to the first mode for indicating transmit beam index information related to the first mode of the base station;
information of the signal beams for indicating the beams related to the first mode;
a pattern of an antenna array for indicating antennas related to the first mode;
codebook information for multiple-input multiple output MIMO transmission;
boresight direction information of the beams;
beam width information;
a beam change flag for indicating whether a beam configuration is adjusted to be related to the first mode; and
information for indicating whether to initiate the first mode.

6. The method of claim 5, wherein the pattern of the beams related to the first mode further comprises at least one of:
information on the number of time units corresponding to the period of the beams related to the first mode,
information on the number of time units occupied by the beams related to the first mode in a period,
information on the number and/or location indexes of the beams related to the first mode in a period.

7. The method of claim 5, further comprising at least one of:
receiving, from the UE, a measurement result and/or a preferred beam index reported after measuring the signal beams related to the first mode;
transmitting, to the UE, first delay configuration information related to the first mode for scheduled uplink signal transmission,
indicating, to the UE through the PDCCH and/or PDSCH in a message msg4, a transmit beam index of the PUCCH, wherein the transmit beam index comprises a transmit beam index corresponding to a corresponding downlink beam index.

8. The method of claim 7,
wherein the measurement result and/or the preferred beam index are received through a PRACH, a msg3 PUSCH, or a msgA PUSCH, wherein the first delay configuration information comprises a first number of time units, and transmitting, to the UE, first delay configuration information for scheduled uplink signal transmission comprises at least one of:
transmitting, through a RAR or a RAR UL grant of a msg2, the first delay configuration information for uplink transmission scheduled by the RAR UL grant;
transmitting, through a PDCCH corresponding to a msg3, the first delay configuration information for uplink transmission of msg3 retransmission scheduled by a DCI UL grant in the PDCCH;
transmitting, through a msg4 PDCCH and/or PDSCH, the first delay configuration information for transmission of the PUCCH corresponding to the PDCCH and/or PDSCH.

9. A user equipment UE, comprising:
a transceiver configured to receive, from a base station, information related to signal beams related to a first mode of the base station; and
a processor operably coupled to the transceiver and configured to perform an operation related to communication based on the information related to the signal beams related to the first mode of the base station,
wherein the information related to the signal beams related to the first mode of the base station comprises at least one of:
a pattern of beams related to the first mode of the base station for indicating transmit beam index information related to the first mode of the base station;
information of the signal beams for indicating the beams related to the first mode of the base station;
a pattern of an antenna array for indicating antennas related to the first mode of the base station;
codebook information for multiple-input multiple output MIMO transmission;
boresight direction information of the beams;
beam width information;
a beam change flag for indicating whether a beam configuration is adjusted to be related to the first mode of the base station; and
information for indicating whether the first mode is initiated.

10. The UE of claim 9,
wherein the operation related to communication comprises at least one of:
measuring the signal beams related to the first mode of the base station, and reporting a measurement result or a preferred beam index;
determining whether the resources corresponding to indexes of the signal beams are valid or available based on whether the signal beams related to the first mode of the base station are turned off;
receiving, from the base station, first delay configuration information related to the first mode for scheduled uplink signal transmission;
obtaining, through the PDCCH and/or PDSCH in the obtained message 4, a transmit beam index indication of the PUCCH indicated by the base station, wherein the transmit beam index indication comprises a transmit beam index corresponding to a corresponding downlink beam index; and
performing at least one of the following operations on a contention resolution timer in random access procedure: extend, stop, reset, pause and restart.

11. The UE of claim 9,
wherein the information related to the signal beams related to the first mode of the base station is received through at least one of:
implicit indication of the information related to the signal beams related to the first mode of the base station;
a specific common search space CSS and/or a specific control resource set CORESET; and
the PDCCH and/or PDSCH corresponding to at least one of a msg2, a msgB and a msg4 in random access procedure, and/or the PDCCH scheduling the msg3 retransmission.

12. The UE of claim 9,
wherein the information related to the signal beams related to the first mode of the base station is received from the base station under a first condition,
wherein the first condition comprises at least one of:
an aggregation level of a search space of the UE satisfying a first threshold;
a serving base station of the UE entering the first mode;
the UE receiving an indication that the base station initiates the first mode; and
the selected beam by the UE being adjusted or changed, wherein the selected beam comprises a preferred beam that the UE has reported to the base station.

13. A base station BS, comprising:
a transceiver configured to transmit, to a user equipment UE, information related to signal beams related to a first mode,
wherein the information related to the signal beams related to the first mode comprises at least one of:
a pattern of beams related to the first mode for indicating transmit beam index information related to the first mode of the base station;
information of the signal beams for indicating the beams related to the first mode;
a pattern of an antenna array for indicating antennas related to the first mode;
codebook information for multiple-input multiple output MIMO transmission;
boresight direction information of the beams;
beam width information;
a beam change flag for indicating whether a beam configuration is adjusted to be related to the first mode; and
information for indicating whether to initiate the first mode.

14. The BS of claim 13, wherein the pattern of the beams related to the first mode further comprises at least one of:
information on the number of time units corresponding to the period of the beams related to the first mode,
information on the number of time units occupied by the beams related to the first mode in a period, and
information on the number and/or location indexes of the beams related to the first mode in a period.

15. The BS of claim 13,
wherein the transceiver is further configured to:
receive, from the UE, a measurement result and/or a preferred beam index reported after measuring the signal beams related to the first mode; and
transmit, to the UE, first delay configuration information related to the first mode for scheduled uplink signal transmission, and
wherein the processor is further configured to:
indicate, to the UE through the PDCCH and/or PDSCH in a message msg4, a transmit beam index of the PUCCH, wherein the transmit beam index comprises a transmit beam index corresponding to a corresponding downlink beam index.
